(19) United States
(12) Patent Application Publication
(10) Pub. No.: US 2002/0187036 A1
(43) Pub. Date: Dec. 12, 2002

(54) Method of feeding blanks to a blank feed store of a packing machine, and blank transfer unit

(75) Inventors: Mario Spatafora, Bologna (IT); Franco Carini, Granarolo Emilia (IT); Vincenzo Luca Ponticelli, Bologna (IT)

Correspondence Address: William R. Evans, Ladas & Parry, 26 West 61 Street, New York, NY, 10023, US

(73) Assignee: G.D SOCIETA' PER AZIONI

(21) Appl. No.: 10/143,511

(22) Filed: May 10, 2002

(30) Foreign Application Priority Data
May 11, 2001 (IT) BO2001A000291

(51) Int. Cl. B65G 59/02

(52) U.S. Cl. 414/796.9; 414/796

(57) ABSTRACT

A transfer unit for transferring blanks and supplying a feed store of a packing machine has two transfer devices, and a first and a second store in which the blanks are arranged in stacks; and the transfer unit supplies the feed store by transferring the stacks of blanks selectively from the first store to the feed store, and from the second store to the feed store.

The present invention relates to a method of feeding blanks to a blank feed store of a packing machine.

More specifically, the present invention relates to a method of feeding blanks to a blank feed store of an automatic packing machine for producing rigid packets of cigarettes, to which the following description refers purely by way example.

### BACKGROUND OF THE INVENTION

To produce rigid packets of cigarettes, a pickup station of the packing machine must be supplied with cardboard blanks so that each blank is withdrawn singly and folded about a group of cigarettes to form a packet of cigarettes. The blanks are flat sheets of cardboard cut and notched beforehand to form fold lines, and are supplied in packages comprising a pallet on which the blanks are arranged for convenient transport and packaging. That is, the blanks in each package are divided into side by side stacks to form layers, which in turn are stacked on the pallet with a separator between one layer and the next. The cigarette packing machine comprises a blank feed store for supplying the pickup station, where each blank is withdrawn by a gripping member and transferred to folding stations of the packing machine. In the feed store, the blanks are arranged in a seamless succession, and are packed together and aligned to set the blanks for pickup by the gripping member to a given position and a given orientation.

In view of the increasingly high output speed of automatic packing machines, the empty pallets must be replaced frequently, so that the transfer unit often remains idle and the feed store soon runs out.

### SUMMARY OF THE INVENTION

It is an object of the present invention to provide a method of feeding blanks to a blank feed store of a packing machine, designed to eliminate the drawbacks of known methods, and which, in particular, prevents the feed store from running out.

According to the present invention, there is provided a method of feeding blanks to a feed store of a packing machine, the method being characterized by comprising the steps of transferring orderly stacks of blanks from a first store to the feed store by means of at least one transfer device; and transferring stacks of blanks from a second store of stacks of blanks to said feed store by means of said transfer device; said first store comprising a pallet in a given position with respect to said transfer device; said pallet having a number of blanks arranged in stacks.

The present invention also relates to a blank transfer unit.

According to the present invention, there is provided a blank transfer unit for feeding blanks to a feed store of a packing machine; the transfer unit being characterized by comprising a first store in which the blanks are arranged in stacks; a second store in which the blanks are arranged in stacks; and at least one transfer device for transferring stacks of blanks from the first store to the feed store, and from the second store of stacks of blanks to said feed store; said first store comprising a pallet on which the blanks are arranged in stacks.

### BRIEF DESCRIPTION OF THE DRAWINGS

A number of non-limiting embodiments of the present invention will be described by way of example with reference to the accompanying drawings, in which:

FIG. 1 shows a schematic plan view, with parts removed for clarity, of a packing machine and the relative transfer unit according to the present invention;

FIG. 2 shows a schematic plan view of a first variation of the FIG. 1 transfer unit;

FIG. 3 shows a schematic plan view of a second variation of the FIG. 1 transfer unit;

FIG. 4 shows a schematic plan view of a third variation of the FIG. 1 transfer unit;

FIGS. 5 and 6 show side views of details of a transfer unit according to the third variation during respective transfer steps; and

FIG. 7 is a plan view of the details shown in FIG. 6.

### DETAILED DESCRIPTION OF THE INVENTION

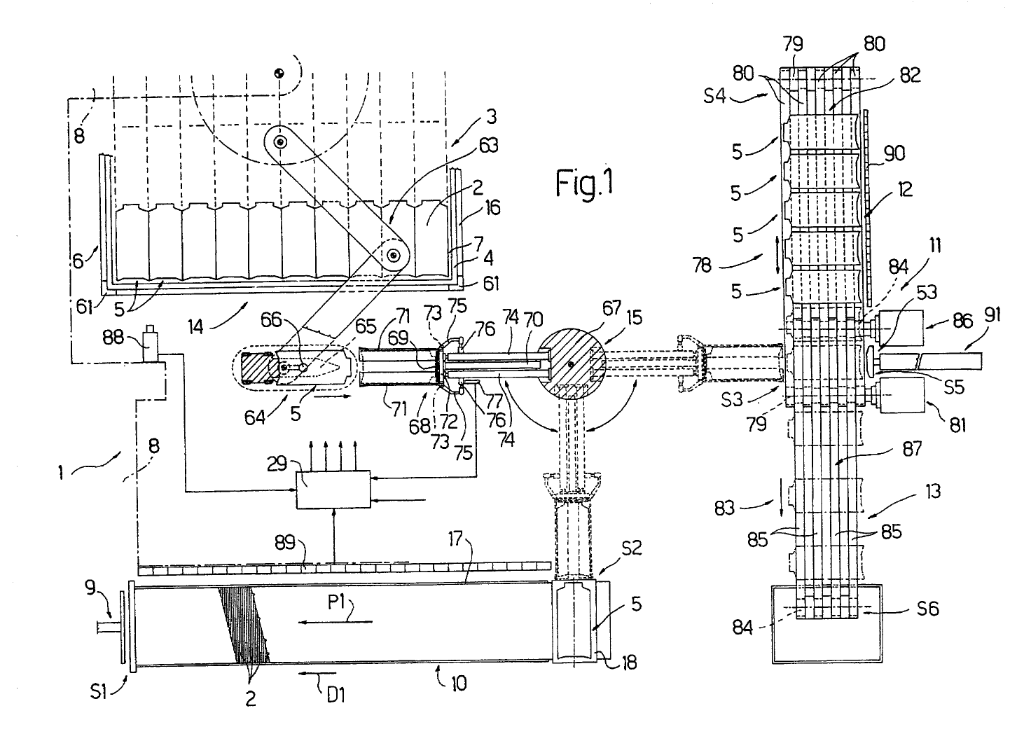

Number 1 in FIG. 1 indicates as a whole a packing machine for producing rigid packets of cigarettes (not shown), each comprising a rigid cardboard blank 2 folded about a group of cigarettes (not shown). Blanks 2 are flat sheets of cardboard cut and notched beforehand to form fold lines (not shown), and are supplied in packages 3, one of which is shown in FIG. 1 and comprises a pallet 4 on which blanks 2 are arranged in orderly fashion.

That is, blanks 2 are divided into side by side stacks 5 to form layers 6, which in turn are stacked on pallet 4 and separated by separators 7. Stacks 5 rest on separators 7, or, in the case of the bottom layer 6, directly on pallet 4, and are loose, i.e. have no wrapping of any sort, to simplify supply of blanks 2 to machine 1. Each blank 2 is defined by a contoured edge aligned with the contoured edges of the other blanks 5 in stack 5; and when one or more blanks 2 are not aligned with the others in stack 5, stack 5 is considered defective.

Machine 1 comprises a frame 8 supporting a gripping member 9 for withdrawing one blank 2 at a time; a store 10 of blanks 2 for feeding blanks 2 to gripping member 9; and a transfer unit 11 for transferring stacks 5 of blanks from pallet 4 to store 10. Gripping member 9 comprises a suction gripping head for withdrawing a blank 2 at a pickup station S1 and feeding blank 2 to folding stations (not shown) of machine 1.

Transfer unit 11 comprises a store 12 of blanks 2; an extractor 13 for extracting faulty stacks 5; two transfer devices 14 and 15 for transferring stacks 5 of blanks; and a locating platform 16 for setting pallet 4 to a given position with respect to transfer device 14.

Store 10 comprises a conveyor 17, which defines a path P1 parallel to a horizontal direction D1 and supports a number of blanks 2 arranged in orderly fashion to assist gripping of a blank 2 by gripping member 9; and an upending member 18 for positioning blanks 2 in stack 5 on edge on conveyor 17. Upending member 18 defines a transfer station S2 where transfer device 15 releases a stack 5 of blanks. In store 10, blanks 2 are arranged in orderly fashion in succession, are packed together and aligned with one other, extend parallel to a vertical plane perpendicular to the FIG. 1 plane, and rest on edge on conveyor 17, which extends a given length from pickup station S1 in horizontal direction D1 to define a stock of blanks 2 for supply to pickup station S1.

Platform 16 comprises locators 61 for centering pallet 4 with respect to platform 16, and is movable in a vertical direction perpendicular to the FIG. 1 plane by means of a lifting device (not shown).

Frame 8 supports transfer device 14 at platform 16, and transfer device 15 at transfer station S2. Transfer device 14 comprises an articulated arm 63 pivoting about vertical axes; and a gripper 64 in turn comprising a blade 65, and a jaw 66 located over blade 65, which is inserted between a separator 7 and the bottom blank 2 in stack 5. Once blade 65 is inserted beneath stack 5, jaw 66 is closed onto stack 5 to extract stack 5 from package 3 and transfer stack 5 to transfer device 15.

Transfer device 15 comprises a shaft 67 rotating about a vertical axis; and a gripping member 68 supported by shaft 67. Gripping member 68 comprises an end wall 69 fitted to telescopic arms 70 extending radially with respect to shaft 67; and two lateral walls 71, which are connected to each other by a plate 72, pivot with respect to plate 72 about respective vertical axes 73, and are supported by telescopic arms 74 parallel to telescopic arms 70 so as to move lateral walls 71 with respect to end wall 69. Each lateral wall 71 is L-shaped to define an end portion for supporting each stack 5, and is connected to an arm 75. Each arm 75 rotates about axis 73 and has one end integral with lateral wall 71, and one end connected to a spring 76 located between arm 75 and plate 72. Spring 76 is equipped with a sensor 77 for detecting the deformation of spring 76 and so determining the angular position of respective wall 71; and sensor 77 is connected to a control unit 29 for determining the deformation of springs 76 and accordingly controlling the movement of transfer device 15.

Store 12 comprises a belt conveyor 78 in turn comprising two pulleys 79, belts 80 looped about pulleys 79, and a drive member 81 connected to one of pulleys 79. Conveyor 78 defines a work branch 82 supporting stacks 5; and a path extending between a release station S3 for releasing stacks 5, and a station S4.

Extractor 13 comprises a belt conveyor 83 in turn comprising two pulleys 84, belts 85 looped about pulleys 84, and a drive member 86 connected to one of pulleys 84. Conveyor 83 defines a work branch 87 supporting stacks 5; and extends between a release station S5 for releasing stacks 5, and a stack unloading station S6. Both conveyors 78, 83 intersect partly at the intersection of respective belts 80, 85, so that release station S3 coincides with station S5. Whether the stack 5 released at station S3 (S) is conveyed along conveyor 78 or conveyor 83 depends on the signal emitted by sensor 77. In other words, drive members 81 and 86 are normally idle, and are activated as a function of the signal emitted by sensor 77.

Transfer unit 11 comprises control unit 29; a television camera 88 for determining the content of pallet 4; a number of sensors 89 located along and for determining the content of store 10; and a number of sensors 90 for determining the content store 12. Control unit 29 calculates variations in the content of store 10 as a function of the content of store 10 determined by sensors 89; and store 12 comprises a pusher 91 located at station S3 (S5) to transfer stacks 5 of blanks from store 12 to gripping member 68.

Platform 16, transfer devices 14, 15, store 12 and extractor 13 are governed by control unit 29.

In actual use, a pallet 4 of blanks is placed on platform 16 in the position determined by locators 61, and the lifting device (not shown) positions package 3 so that the top separator 7 coincides with a given plane. Transfer device 14 removes one stack 5 at a time off layer 6 by means of gripper 64, and transfers each stack 5 to transfer device 15. Upon transfer device 14 removing a whole layer 6 from package 3, separator 7 is removed and platform 16 is raised so that the next separator 7 coincides with said given plane. Transfer device 15 selectively sets gripping member 68 to a receiving position, as shown by the continuous line in FIG. 1; to a transfer position at station S2, as shown by the dash line in FIG. 1; and to a release position at station S3 (S5), as shown by the dash line. In the receiving position, gripper 64 inserts a stack 5 between walls 71 and into contact with end wall 69 of gripping member 68; and stack 5 is supported by the respective spaced end portions of L-shaped lateral walls 71. Blade 65 is inserted between the end portions of lateral walls 71, and, in the event stack 5 is not aligned with gripper 64 or is faulty, lateral walls 71, by virtue of being mounted flexibly, flex and exert pressure on the faulty stack 5 to arrange blanks 2 in stack 5 correctly inside gripping member 68 by virtue of springs 76, which tend to position walls 71 parallel to and aligned with each other. If walls 71, under the effect of springs 76, fail to correct the defect of stack 5 or blanks 2 with respect to gripping member 68, sensors 77 detect persistent deformation of springs 76 with respect to an optimum or threshold value, and transmit an error signal to control unit 29, which commands that gripping member 68 be set to the release position, and stack 5 be released at station S3 (S5), by extending arms 70 to feed forward end wall 69, and subsequently expelled by conveyor 83. In other words, control unit 29 activates drive member 86.

Conversely, if the signal transmitted to control unit 29 indicates no persistent deformation of springs 76 with respect to the optimum or threshold value, i.e. stack 5 shows no defects, control unit 29 determines the content of stores 10 and 12 and the variations in the content of store 10, and determines whether to transfer stack 5 to station S2 or to station S3 (S5). When store 10 is full and store 12 empty, transfer device 15 transfers stack 5 to store 12 to form a stock of stacks 5. Conversely, if store 10 is about to run out, stack 5 is transferred to upending member 18, which upends stack 5 to set blanks 2 on edge along conveyor 17.

As pallet 4 is about to run out, television camera 88 emits a signal to change pallet 4, and, once the pallet is empty, control unit 29 commands transfer device 15 to pick up the stacks 5 in store 12, in the course of which, pickup member 68 is positioned at station S3 (S5) to receive one stack 5 at a time from pusher 91. Conveyor 78 is operated in steps to feed one stack 5 at a time into station S3 (S5); the stacks 5 picked up by transfer device 15 are checked and, on the basis of the signal emitted by sensor 77, are fed directly back to extractor 13 at station S3 (S5), or to transfer station S2 for transfer to store 10.

Stacks 5 are picked up from store 12 and transferred until a new pallet 4 is positioned on platform 16 and as long as store 12 contains stacks 5.

In other words, platform 16 and pallet 4 define a first store of stacks 5 of blanks, while store 12 defines a second store for alternatively feeding stacks 5 of blanks to feed store 10 of packing machine 1 by means of transfer unit 11.

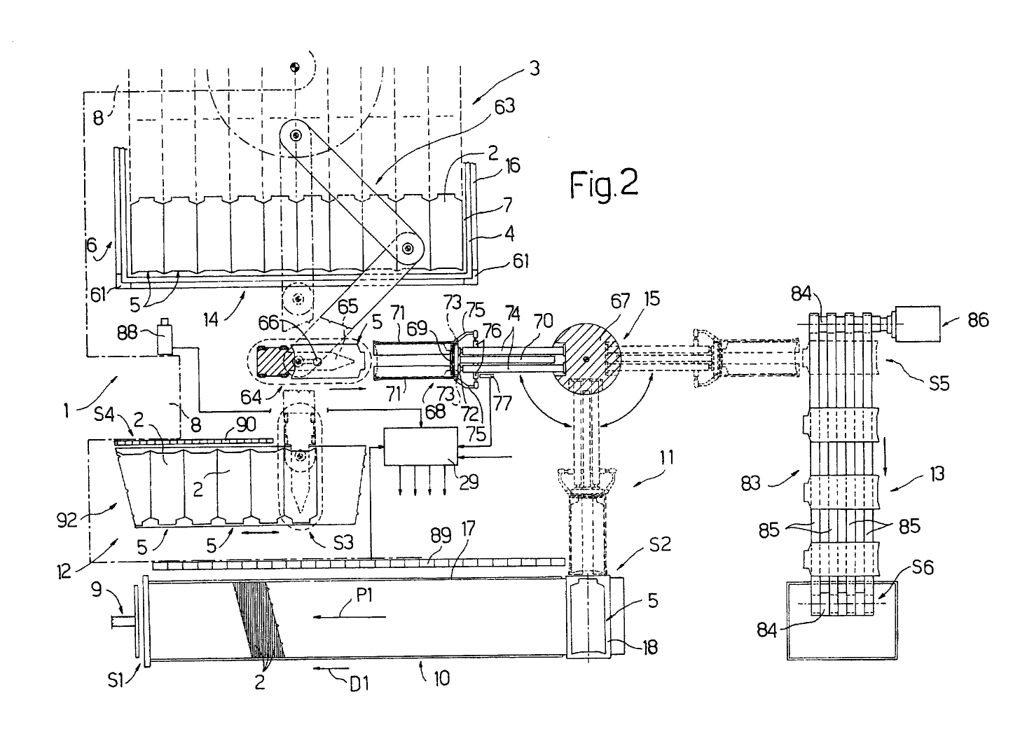

In the FIG. 2 variation, store 12 and extractor 13 have respective separate stations S3 and S5 and are not linked as in FIG. 1, and pusher 91 is eliminated. Store 12 comprises a conveyor 92 onto which stacks 5 of blanks are deposited by transfer device 14 at station S3, and are picked up by transfer device 14 at station S3 or station S4. Once picked up from store 12, stacks 5 are transferred to transfer device 15, which checks each stack 5 for defects, attempts to correct any defects in stack 5, and transfers any faulty stacks 5 to extractor 13, and the stacks 5 with no defects to feed store 10.

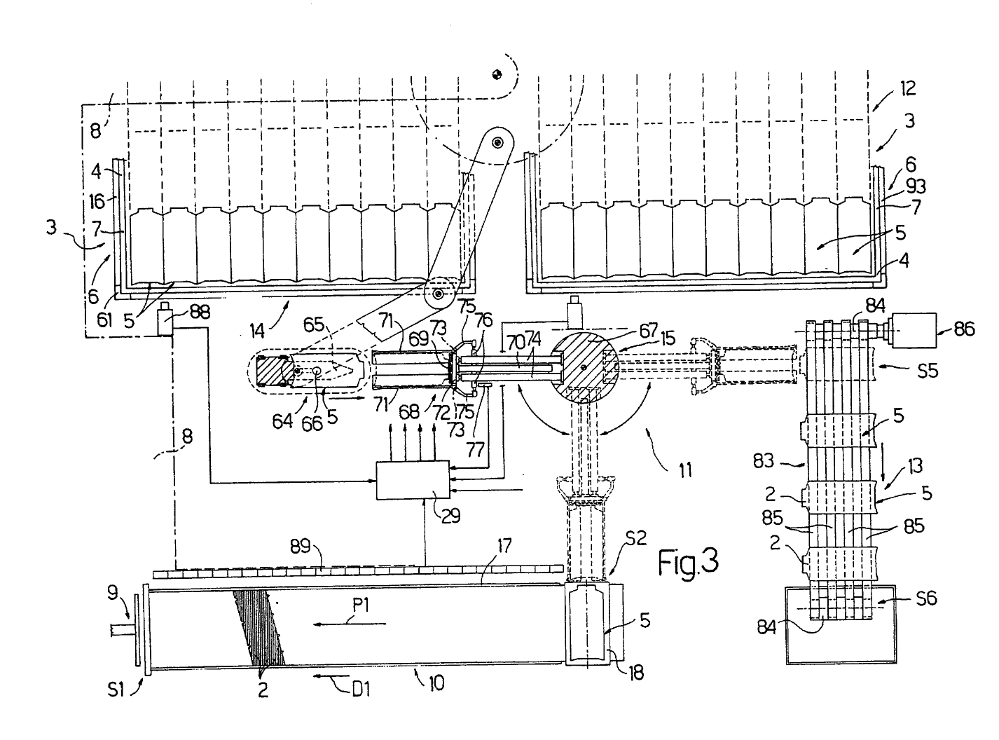

In the FIG. 3 variation, store 12 comprises a further platform 93 alongside platform 16, and a further pallet 4 on platform 93. When a pallet 4 runs out, the transfer unit picks up stacks 5 of blanks off the further pallet 4.

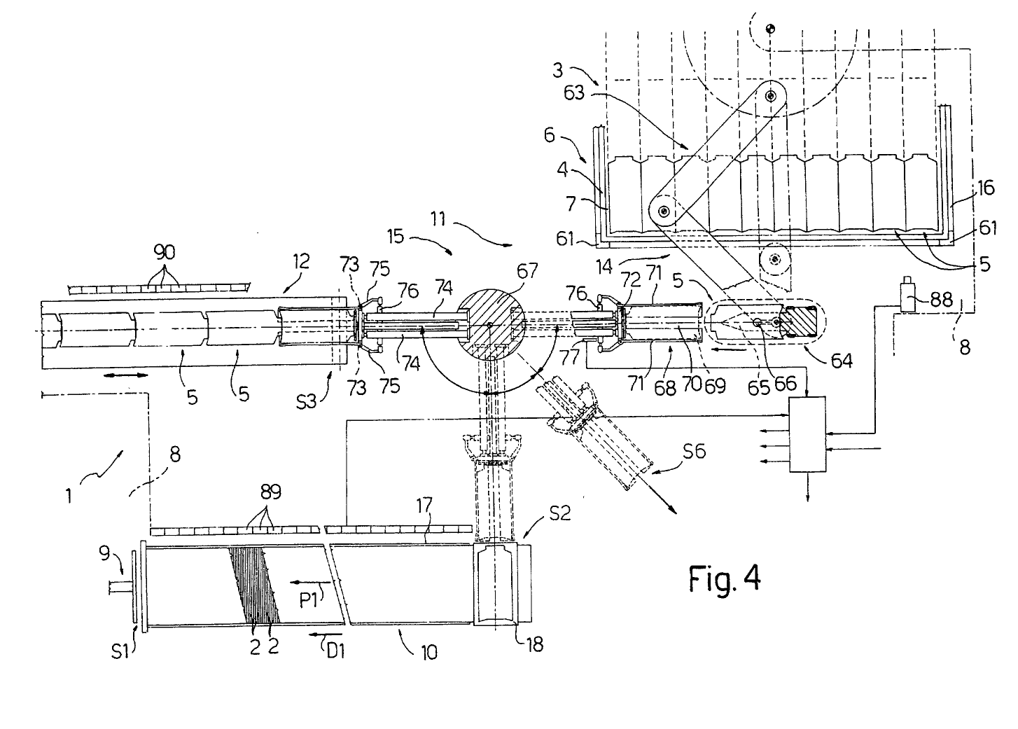

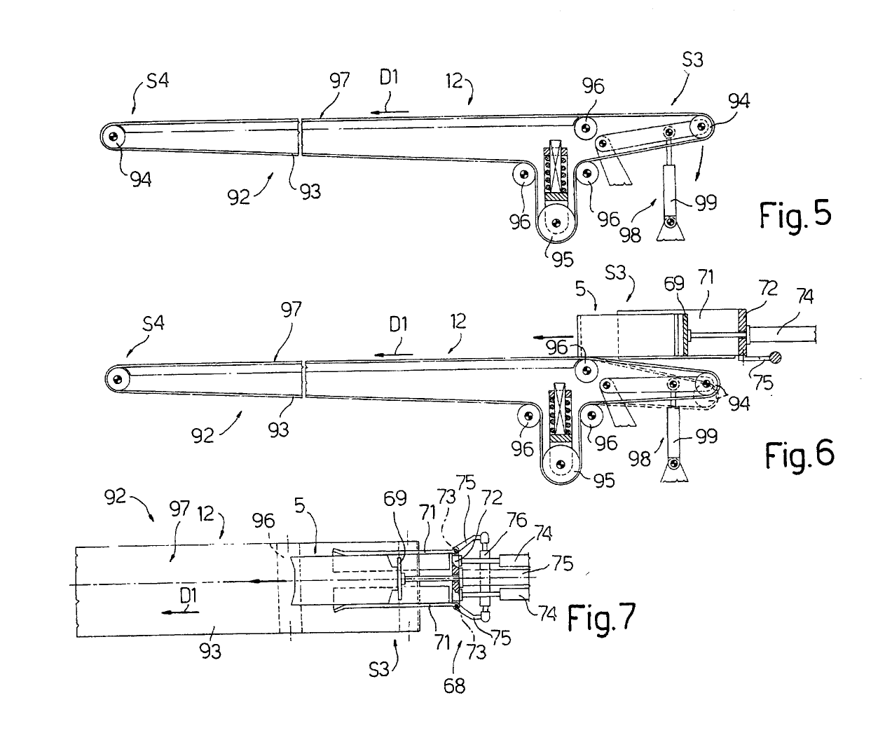

In the FIG. 4 variation, the extractor 13 is eliminated and the store 12 is located beside conveyor 17 along horizontal direction D1. As better shown in FIG. 5 and 6, the store 12 comprises a belt conveyor 92 having a belt 93 looped about two end pulleys 94, a compensation pulley 95, and three diverting pulleys 96. An upper work branch 97 of belt conveyor 92 extends between release station S3 and station S4. The end pulley 94 located in the release station S3 is supported by a mechanism 98 having an actuator 99 for moving the end pulley 94 between a rest position shown in FIG. 5; a lowered position shown in phantom in FIG. 6 and a working position shown in FIG. 6.

With reference to FIG. 5, In the rest position the end pulleys 94 and a diverting pulley 96 are aligned in the horizontal direction D1 so that the work branch 97 be straight and parallel to direction D1. When the pulley 94 is located in the lowered position and in the working position (FIG. 6) an end portion of the work branch 97 is bent about the diverting pulley 96. The position of the end pulley 94 is controlled by the control unit 29 and is determined by the working steps of the transfer unit 11.

In use, the transfer device 15 pivots about the vertical axis of shaft 67 and rests selectively in four positions in which receives a stack 5 from transfer device 14, unloads a defective stack 5 in station S6 releases the stack 5 to the upending member 18 in station S2 and releases/picks up the stack 5 to/from store 12 in station S3.

The release of a stack 5 from the transfer device 15 to store 12 is shown in details in FIGS. 5, 6 and 7 and is performed so as to maintain the longer side of the stacks 5 parallel to direction D1. In FIG. 5, the conveyor belt 92 is in a rest position, when the control unit 29 emits a signal that the transfer device 15 is ready to release a stack 5 in the store 12 the mechanism 98 lowers the end pulley 94 (FIG. 6) in the lowered position in order to allow the gripping member 68 being located in the release station S3, since the transfer device 15 is designed so that the quote of the gripping member 68 cannot be varied. Then, the end pulley 94 is lifted to the working position so that the belt 93 be adjacent to the bottom of the side walls 71 of the gripping member 68 and the telescopic arms 70 push the end wall 69 and the stack 5 forwards as depicted in FIGS. 6 and 7 for releasing the stack 5 on the upper work branch 97 of conveyor 92 without any substantial gap between the belt 92 and the gripping member 68. In the meantime, the belt 93 is moved at same speed of the end wall 69 together with the stack 5 laying partially on the belt 93. Once the stack 5 lies completely on belt 93, the end pulley 94 is lowered again to allow the gripping member 68 being removed from release station S3.

In that way, a number stacks 5 can be successively stored on the work branch 97 of the conveyor 92. In a similar way, the stacks 5 can be picked up from conveyor 92: the end pulley 94 located in proximity of station S3 is lowered in the lowered position; the empty gripping member 68 is located in S3; the end pulley 94 is lifted in the working position so that the belt 93 be adjacent to the bottom of side walls 71 of gripping member 68; the belt 93 and the stacks 5 are moved towards the gripping member 68: as a consequence of the movement of the stacks 5, the stack 5 which is closest to station S3 enters between the side walls 71 of the gripping member 68 till the stack 5 is completely held by the gripping member 68. Then, the end pulley 94 is again lowered in the lowered position to allow the gripping member 68 being removed from station S3.

1. A method of feeding blanks to a feed store of a packing machine, the method being characterized by comprising the steps of transferring orderly stacks (5) of blanks from a first store (4, 16) to the feed store (10) by means of at least one transfer device (14, 15); and transferring stacks (5) of blanks from a second store (12) of stacks (5) of blanks to said feed store (10) by means of said transfer device (14, 15); said first store (4, 16) comprising a pallet (4) in a given position with respect to said transfer device (14, 15); said pallet (4) having a number of blanks arranged in stacks (5).

2. A method as claimed in claim 1, characterized by transferring at least some of the stacks (5) of blanks from the first store (16, 4) to the second store (12).

3. A method as claimed in claim 1, characterized by placing the pallet (4) on a platform (16) defining a given position of said pallet (4); said first store (4; 16) comprising said platform (16).

4. A method as claimed in claim 3, characterized in that said platform (16) comprises locating members (61) for positioning the pallet (4).

5. A method as claimed in claim 4, characterized by unloading an empty pallet (4) off said platform (16), loading a full pallet (4) onto said platform (16), and transferring said stacks (5) of blanks from the second store (12) to the feed store (10) as the full pallet (4) is being substituted for the empty pallet (4).

6. A method as claimed in claim 1, characterized by detecting a characteristic of each stack (5) by means of said transfer device (15) as each stack (5) of blanks is transferred by said transfer device (15); and emitting a signal related to the characteristic of said stack (5) and indicating a defect in said stack (5).

7. A method as claimed in claim 6, characterized in that said characteristic is alignment of the blanks (2) in the stack (5) of blanks.

8. A method as claimed in claim 6, characterized by transferring to the feed store (10) the stacks (5) whose signals are below a threshold value, and to an extractor (13) the faulty stacks (5) whose signals are above a threshold value.

9. A method as claimed in claim 1, characterized in that the second store (12) comprises a conveyor (78; 92) supporting a number of stacks (5) of blanks.

10. A method as claimed in claim 9, characterized by conveying said stacks (5) of blanks on said conveyor (78; 92).

11. A method as claimed in claim 9, characterized by transferring said stacks (5) of blanks to and from said conveyor (92) by raising the belt (93) of said conveyor (92) against the gripping member (68) of the transfer device (15).

12. A method as claimed in claim 11, characterised by lowering at least an end pulley (94) of the conveyor (92); positioning the gripping member (68) above said pulley (94); lifting said pulley (94) so that the belt (93) be adjacent to the bottom of the gripping member (68).

13. A blank transfer unit for feeding blanks to a feed store (10) of a packing machine; the transfer unit (11) being characterized by comprising a first store (16, 4) in which the blanks (2) are arranged in stacks (5); a second store (12) in which the blanks are arranged in stacks (5); and at least one transfer device (14, 15) for transferring stacks (5) of blanks from the first store (16, 4) to the feed store (10), and from the second store (12) of stacks (5) of blanks to said feed store (10); said first store (16, 4) comprising a pallet (4) on which the blanks (2) are arranged in stacks (5).

14. A unit as claimed in claim 13, characterized by comprising a control unit (29) for controlling said transfer device (14, 15) as a function of signals related to a characteristic of the stacks (5) of blanks, and to the content of the first store (16, 4), the second store (12) and the feed store (10).

15. A unit as claimed in claim 14, characterized in that said first store (16, 4) comprises a platform (16) for setting a pallet (4) to a given position with respect to the transfer device (14, 15).

16. A unit as claimed in claim 13, characterized in that said transfer device (15) comprises a gripping member (68) for determining any defects in a stack (5) of blanks as it grips said stack (5).

17. A unit as claimed in claim 16, characterized by comprising an extractor (13) for extracting any faulty stacks (5); said transfer device (15) feeding said faulty stacks (5) to said extractor (13).

18. A unit as claimed in claim 17, characterized in that said extractor (13) comprises a second conveyor (83); the first and second conveyor (78, 83) a common portion along which a release station (S3) is located.

19. A unit as claimed in claim 13, characterized in that the second store (12) comprises a first conveyor (92) comprising a belt (93) having a an upper work branch (97) and supporting a number of stacks (5) of blanks on said upper work branch (97).

20. A unit as claimed in claim 19, characterized in that said transfer device (15) comprises a gripping member (68); said first conveyor (92) comprising actuating means (94, 98, 99) for raising said belt (93) against said gripping member (68) in a release station (S3).

21. A unit as claimed in claim 20, characterised in that said actuating means (94, 98, 99) comprise an end pulley (94) of the first conveyor (92), a mechanism (98) and an actuator (99) for lifting and lowering said end pulley (94) and at least a portion of said belt (93) so that the belt be adjacent to the bottom of said gripping member (68).

22. A unit as claimed in claim 13, characterized in that said second store (12) comprises a further platform (93); and a further pallet (4) of stacks (5) of blanks supported on said further platform (93).
